(19) United States
(12) Patent Application Publication
(10) Pub. No.: US 2013/0297284 A1
(43) Pub. Date: Nov. 7, 2013

(54) APPARATUS AND METHOD FOR GENERATING POLITE EXPRESSIONS FOR AUTOMATIC TRANSLATION

(71) Applicants: Sung-Kwon Choi, Daejeon (KR); Oh-Woog Kwon, Daejeon (KR); Ki-Young Lee, Daejeon (KR); Yoon-Hyung Roh, Daejeon (KR); Young-Kil Kim, Daejeon (KR); Sang-Kyu Park, Daejeon (KR)

(72) Inventors: Sung-Kwon Choi, Daejeon (KR); Oh-Woog Kwon, Daejeon (KR); Ki-Young Lee, Daejeon (KR); Yoon-Hyung Roh, Daejeon (KR); Young-Kil Kim, Daejeon (KR); Sang-Kyu Park, Daejeon (KR)

(73) Assignee: ELECTRONICS AND TELECOMMUNICATIONS RESEARCH INSTITUTE, Daejeon (KR)

(21) Appl. No.: 13/566,486

(22) Filed: Aug. 3, 2012

(30) Foreign Application Priority Data
May 2, 2012 (KR) 10-2012-0046138

(51) Int. Cl. G06F 17/28

(52) U.S. Cl. 704/2

(57) ABSTRACT

Disclosed herein are an apparatus and method for generating polite expressions for automatic translation. The apparatus includes a relationship recognition unit, a polite level selection unit, and a translation unit. The relationship recognition unit extracts relationship information from a conversation between first and second language users and personal information of the first and second language users and then recognizes the social relationship between the language users. The polite level selection unit selects a polite level for the conversation between the first and second language users based on the extracted relationship information. The translation unit generates polite expressions corresponding to the selected polite level, and translates the conversation between the first and second language users into a target language based on the generated polite expressions.

### CROSS REFERENCE TO RELATED APPLICATION

This application claims the benefit of Korean Patent Application No. 10-2012-0046138, filed on May 2, 2012, which is hereby incorporated by reference in its entirety into this application.

### BACKGROUND OF THE INVENTION

1. Technical Field

The present invention relates generally to an apparatus and method for generating polite expressions for automatic translation and, more particularly, to an apparatus and method for generating polite expressions for automatic translation that are capable of overcoming the linguistic and cultural differences between polite expressions.

2. Description of the Related Art

Currently, with the popularization of the Internet, an information channel has been established across the world, yet the communication channel is still blocked because of language barriers between countries. For this reason, in reality, the Internet is segmented into intranets by the borders of respective countries.

Conventional English-to-Korean translation technology is dependent on automatic English-to-Korean translation technology. Automatic translation technology is technology that translates text in a foreign language into text in another language such as the native language using, for example, the processing capability of a computer system. In automatic translation technology, a database that models the knowledge of languages is established, and a translation engine performs translation while referring to this database. However, it is difficult to achieve an automatic translation above a predetermined quality while reliably reflecting the intention of the original text because of the polysemy of natural language. Furthermore, the problems and limitations of the conventional automatic translation technology are as follows:

First, the conventional rule-based automatic translation approach cannot achieve complete translation because natural languages have many exceptions such as the polite expressions of Korean. This defect always generates a single type of polite expression regardless of the interlocutors, thereby making automatic translation results unnatural and confusing the context of a conversation. For example, even if automatic translation were to generate a different type of polite expression for a different interlocutor, the conventional automatic translation technology has the problem of always generating a single type of polite expression.

Second, the conventional automatic translation technology has the problem of having no countermeasures against input that does not comply with rules, such as typographical errors and ungrammatical sentences.

In order to overcome the problems of the conventional simple automatic translation technology, Korean Patent No. 265548 discloses an automatic translation method and apparatus that provide a plurality of translation environments and enable a translation environment related to a genre, field, and purpose to which the original text pertains to be automatically selected. However, this invention simply attains the level of determining the field to which a sentence belongs, selecting a translation environment suitable for the field and translating the sentences in the selected environment rather than improving a translation apparatus and method themselves.

Furthermore, Korean Patent Application No. 1997-37040 discloses an idiom translation method for an automatic English-to-Korean translation system. This invention relates to a method of dividing each sentence into words, performing translation using morpheme interpretation, and processing normal idiomatic expressions while referring to an idiom dictionary. However, this invention extends the translation capability from word translation to idiom translation, but does not extent the capability to overall sentence translation.

As described above, the conventional automatic English-to-Korean translation technologies have the advantage of improving the general translation level, but are limited in their ability to translate Korean polite expressions.

### SUMMARY OF THE INVENTION

Accordingly, the present invention has been made keeping in mind the above problems occurring in the prior art, and an object of the present invention is to provide an apparatus and method for generating polite expressions for automatic translation, which decide the social relationship with an interlocutor based on non-linguistic information such as personal information provided by a social network, and linguistic information such as conversational expressions, when translating a conversation between first and second language users into a target language, thereby overcoming linguistic and cultural differences between polite expressions and then providing automatic translation results.

Another object of the present invention is to provide an apparatus and method for generating polite expressions for automatic translation, which decide the social relationship with an interlocutor and select a polite level for a conversation between first and second language users, thereby providing automatic translation results suitable for the interlocutor.

In order to accomplish the above object, the present invention provides an apparatus for generating polite expressions for automatic translation, including a relationship recognition unit for extracting relationship information from a conversation between first and second language users and personal information of the first and second language users and then recognizing the social relationship between the language users; a polite level selection unit for selecting a polite level for the conversation between the first and second language users based on the extracted relationship information; and a translation unit for generating polite expressions corresponding to the selected polite level and translating the conversation between the first and second language users into a target language based on the generated polite expressions.

The relationship information may be information including at least one of lexical expression information, age information, relationship intimacy information and social association information extracted from the conversation and the personal information.

The relationship recognition unit may include a first information collection unit for collecting lexical expression information from the conversation between the first and second language users; a part-of-speech classification unit for classifying the collected lexical expression information into parts of speech; and a first information extraction unit for extracting the information about the relationship between the first and second language users by analyzing results of the classification into the parts of speech.

The part-of-speech classification unit may classify the lexical expression information into parts of speech such as a lexical honor, an affix, a particle, a prefinal ending, and a final ending.

The relationship recognition unit may include a second information collection unit for collecting personal information from social networks that are used by the first and second language users; and a second information extraction unit for extracting the information about the relationship between the first and second language users by analyzing the collected personal information.

The relationship recognition unit may include an information provision unit for receiving the relationship information from the first and second language users and providing the relationship information.

The polite level selection unit may include a level classification unit for classifying a polite level into a plurality of preset polite levels; and a level mapping unit for selecting and assigning a polite level for the conversation between the first and second language users by mapping the extracted relationship information into one of the classified polite levels.

The translation unit may include a polite expression generation unit for generating the polite expressions corresponding to the selected polite level; a morpheme analysis unit for performing morpheme analysis on sentences of the conversation between the first and second language users;

a structure analysis unit for analyzing structures of the sentences of the conversation between the first and second language users while referring to a translation memory DB and a translation pattern DB; a translation generation unit for generating a translation in which the sentences of the conversation between the first and second language users have been converted into the target language while referring to morphemes and structures, obtained by the analysis based on the generated polite expressions, and the translation pattern DB and a translation dictionary DB; and a translation output unit for outputting the generated translation.

In order to accomplish the above object, the present invention provides a method of generating polite expressions for automatic translation, including, by a relationship recognition unit, extracting relationship information from a conversation between first and second language users and personal information of the first and second language users, and then recognizing the social relationship between the language users; by a polite level selection unit, selecting a polite level for the conversation between the first and second language users based on the extracted relationship information; and by a translation unit, generating polite expressions corresponding to the selected polite level, and translating the conversation between the first and second language users into a target language based on the generated polite expressions.

The recognizing the social relationship between the language users may include extracting the information about the relationship between the first and second language users by analyzing results obtained by classifying lexical expression information, collected from the conversation between the first and second language users, into parts of speech.

The recognizing the social relationship between the language users may include extracting the information about the relationship between the first and second language users by analyzing personal information collected from social networks that are used by the first and second language users.

The recognizing the social relationship between the language users may include receiving the relationship information from the first and second language users.

The selecting a polite level for the conversation between the first and second language users may include selecting the polite level for the conversation between the first and second language users by performing mapping to one of a plurality of preset levels.

The translating the conversation between the first and second language users into a target language may include generating and outputting a translation in which sentences of the conversation between the first and second language users have been converted into the target language while referring to morphemes and structures obtained by analysis based on the generated polite expressions.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of an apparatus for generating polite expressions for automatic translation according to an embodiment of the present invention;

FIG. 2 is a diagram showing the detailed configuration of the relationship recognition unit of the apparatus for generating polite expressions for automatic translation according to the present invention;

FIG. 3 is a diagram showing the detailed configuration of the polite level calculation of the apparatus for generating polite expressions for automatic translation according to the present invention;

FIG. 4 is a diagram showing the detailed configuration of the translation unit of the apparatus for generating polite expressions for automatic translation according to the present invention;

FIG. 5 is a flowchart showing a method of generating polite expressions for automatic translation according to an embodiment of the present invention;

FIG. 6 is a flowchart showing the process of extracting relationship information that enables the social relationship between the first and second language users to be decided in the method of generating polite expressions for automatic translation according to the present invention;

FIG. 7 is a flowchart showing the process of selecting a polite level for a conversation between the first and second language users based on relationship information based on extracted lexical expression information in the method of generating polite expressions for automatic translation according to the present invention;

FIG. 8 is a flowchart showing the process of selecting a polite level for a conversation between the first and second language users based on relationship information based on extracted personal information in the method of generating polite expressions for automatic translation according to the present invention; and

FIG. 9 is a flowchart showing the process of selecting a polite level for a conversation between the first and second language users based on relationship information based on relationship information received directly from users in the method of generating polite expressions for automatic translation according to the present invention.

### DESCRIPTION OF THE PREFERRED EMBODIMENTS

Preferred embodiments of the present invention will be described in detail with reference to the accompanying drawings in order to enable those having ordinary knowledge in the field of art to which the present invention pertains to easily practice the technical spirit of the present invention. It should be noted that the same or similar reference numerals are used to designate similar and identical elements throughout the accompanying drawings. Furthermore, in the following description of the present invention, detailed descriptions of well-known functions or configurations which would unnecessarily obscure the gist of the present invention will be omitted.

An apparatus and method for generating polite expressions for automatic translation according to an embodiment of the present invention will be described in detail below with reference to the accompanying drawings.

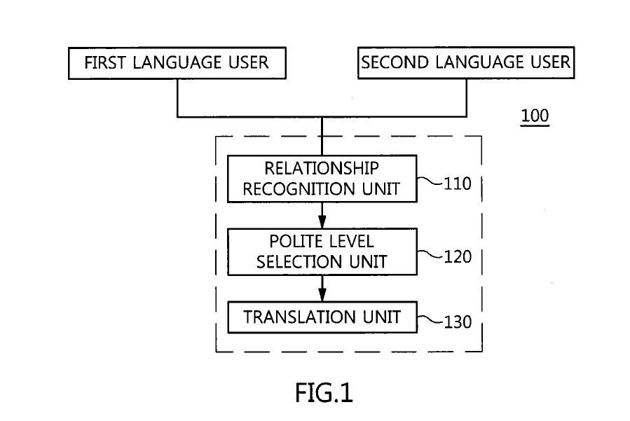

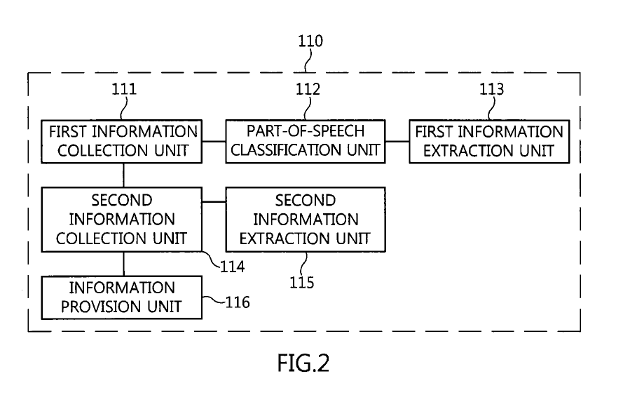

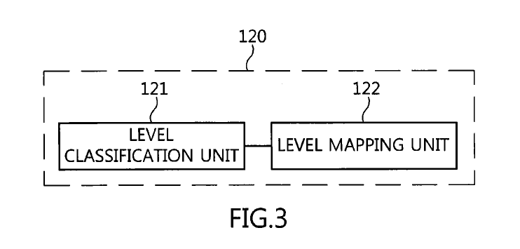

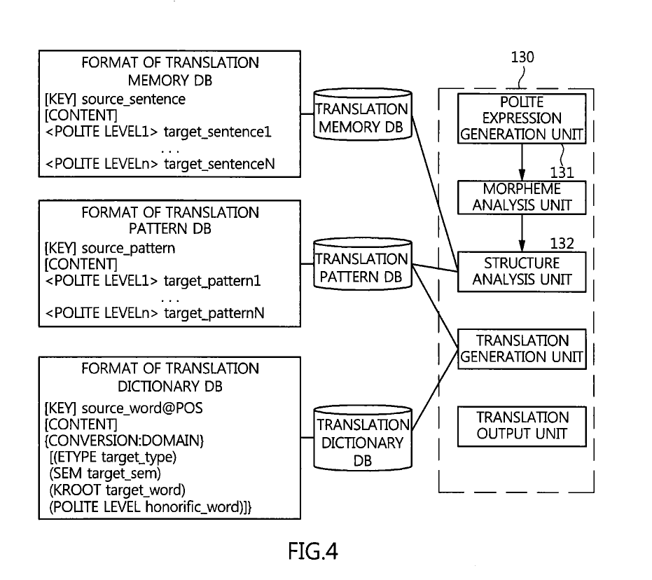

FIG. 1 is a diagram showing the configuration of an apparatus for generating polite expressions for automatic translation according to an embodiment of the present invention, FIG. 2 is a diagram showing the detailed configuration of the relationship recognition unit of the apparatus for generating polite expressions for automatic translation according to the present invention, FIG. 3 is a diagram showing the detailed configuration of the polite level calculation of the apparatus for generating polite expressions for automatic translation according to the present invention, and FIG. 4 is a diagram showing the detailed configuration of the translation unit of the apparatus for generating polite expressions for automatic translation according to the present invention.

Referring to FIG. 1, an apparatus 100 for generating polite expressions for automatic translation according to the present invention may include a relationship recognition unit 110, a polite level selection unit 120, and a translation unit 130 to generate polite expressions suitable for an interlocutor when automatically translating a conversation between a first language user and a second language user.

In the present invention, the first language user is a user who uses Korean, and the second language user is a user who uses any language other than Korean. However, the present invention will be described with the second language user being a user who uses English.

The relationship recognition unit 110 extracts relationship information from a conversation between the first and second language users and the personal information of the first and second language users, and recognizes the social relationship between the language users.

Here, the relationship information is information including at least one of lexical expression information, age information, relationship intimacy information, and social association information extracted from the conversation and the personal information.

That is, the relationship recognition unit 110 obtains age information, relationship intimacy information, and social association information from previously stored information about the relationship between the first and second language users, lexical expression information collected from the conversation between the first and second language users, the personal information of the first and second language users collected from a social network, and relationship information input directly by the first and second language users, and recognizes the social relationship between the first and second language users.

In greater detail, if the relationship between the first and second language users has already been stored, the relationship recognition unit 110 immediately extracts information about the relationship between the two language users, and transfers the information to the polite level selection unit 120. In contrast, if the relationship between the first and second language users has not been stored, the relationship recognition unit 110 immediately extracts relationship information from the conversation between the two language users and personal information, and transfers the information to the polite level selection unit 120. Furthermore, if relationship information cannot be extracted even from the conversation between the first and second language users or personal information, the relationship recognition unit 110 may receive relationship information directly from the two language users, and transfer it to the polite level selection unit 120.

For this purpose, the relationship recognition unit 110, as shown in FIG. 2, may include a first information collection unit 111, a part-of-speech classification unit 112, a first information extraction unit 113, a second information collection unit 114, a second information extraction unit 115, and an information provision unit 116.

The first information collection unit 111 may collect lexical expression information from the conversation between the first and second language users.

The part-of-speech classification unit 112 may classify the collected lexical expression information into parts of speech. Here, the part-of-speech classification unit 112 may classify lexical expression information into parts of speech, such as a lexical honor, an affix, a particle, a prefinal ending, and a final ending. For example, the lexical honor is classified as an ordinary lexicon or a polite lexicon, the affix is “ [symbol] (Transliteration: nim; affix of polite lexicon),” the particle is “ [symbol] (Transliteration: kkaeseo; particle of polite lexicon),” the prefinal ending is “ [symbol] (Transliteration: si; prefinal ending of polite lexicon),” and the final ending is classified as “ [symbol] (Transliteration: haerache; final ending of ordinary lexicon),” “ [symbol] (Transliteration: haeche; final ending of ordinary lexicon),” “ [symbol] (Transliteration: haeyoche; final ending of polite lexicon),” “ [symbol] (Transliteration: hapsyoche, final ending of polite lexicon),” or the like. Here, “ [symbol] (Transliteration: haeche)” may have a polite level higher than “ [symbol] (Transliteration: haerache)”. “ [symbol] (Transliteration: haeyoche)” may have polite level higher than “ [symbol] (Transliteration: haerache)”. “ [symbol] (Transliteration: hapsyoche)” may have polite level higher than “ [symbol] (Transliteration: haeyoche)”.

The first information extraction unit 113 may extract information about the relationship between the first and second language users by analyzing the results of the part-of-speech classification.

The second information collection unit 114 may collect personal information from social networks that are used by the first and second language users. That is, the second information collection unit 114 may estimate the social relationship between the two language users using the disclosed personal profiles and digital personal connection information of the two language users obtained from a social network such as Facebook or Twitter. In this case, the reason why the personal information disclosed over the social network is used is that the illegitimate use of personal information violates the personal information usage-related prescriptions of Information Communications Laws.

The second information extraction unit 115 may extract information about the relationship between the first and second language users by analyzing the collected personal information.

The information provision unit 116 may receive relationship information directly from the first and second language users. That is, when relationship information cannot be extracted from the conversation between the first and second language users, the information provision unit 116 receives relationship information by means of the selection of options from a previously stored relationship menu by the first and second language users. Here, examples of a variety of relationships, such as a friend, an intimate junior colleague, an intimate senior colleague, an intimate professor, an intimate boss, and a stranger, have been stored in the previously stored relationship menu.

The polite level selection unit 120 selects a polite level for the conversation between the first and second language users based on the extracted relationship information.

For this purpose, the polite level selection unit 120, as shown in FIG. 3, may include a level classification unit 121 and a level mapping unit 122.

The level classification unit 121 classifies polite expressions into a plurality of levels. In this case, the level classification unit 121 according to the present invention determines a polite level based on the relationship information extracted by the relationship recognition unit 110, and classifies the polite level as one in a range from the lowest level 0 to the highest level 3. The levels are not limited thereto.

The level mapping unit 122 selects and allocates a polite level for the conversation between the first and second language users by mapping the extracted relationship information to one of preset polite levels. For example, when the relationship information has been decided based on lexical expression information, the level mapping unit 122 may map the relationship information to polite level 0 in the case in which the final ending corresponds to “ [symbol] (Transliteration: haeche),” as in “ [symbol] (Transliteration: i-geo-jom-hae, Translation: Do some of this)” or “ [symbol] (Transliteration i-geo-jom-doe-wa-jwer, Translation: Help me do some of this)” to polite level 1 in the case in which the final ending corresponds to “ [symbol] (Transliteration: haeyoche)” as in “ [symbol] (Transliteration: i-geo-jom-haeyo!, Translation: Please do some of this!)” or “ [symbol] (Transliteration: i-geo-jom-doe-wa-jwer-yo!, Translation: Please help me do some of this!),” to polite level 2 in the case in which the lexical honor corresponds to a polite lexicon, the affix is “ [symbol] (Transliteration: nim),” the prefinal ending is “ [symbol] (Transliteration: si)” and the final ending corresponds to “ [symbol] (Transliteration: haeyoche),” as in “ [symbol] , [symbol] (Transliteration: kwa-jang-nim,-sik-sa-ha-shut-a-yo?Translation: Did you have a meal, supervisor?)” and to polite level 3 in the case in which the lexical honor corresponds to a polite lexicon, the affix is “ [symbol] (Transliteration: nim),” the particle is “ [symbol] (Transliteration: kkeseo),” the affix is “ [symbol] (Transliteration: nim),” the prefinal ending is “ [symbol] (Transliteration: si)” and the final ending corresponds to “ [symbol] ((Transliteration: hapsyoche)”, as in “ [symbol] [symbol] [symbol] (Transliteration: a-beo-nim.-Jin-ji-jap-sue-shut-seup-ni-kka?, Translation: Did you have a meal, father?).” An example of the polite level mapping method of the level mapping unit 122 for the cases in which relationship information is decided from personal information other than the above-described lexical expression information or by the direct input of the relationship information will be described in detail below.

The translation unit 130 generates polite expressions corresponding to the selected polite level, and translates the conversation between the first and second language users into a target language based on the generated polite expressions. The translation unit 130 generates and outputs a polite expression in accordance with the selected polite level. As a simple example, when the second language user utters “I can tell you the web site,” it is translated into the expression “ [symbol] [symbol] (Transliteration: website-leul-mal-hae-jul-sue-it-seup-ni-da)” in the case in which polite level 3 has been selected for the conversation, and it is translated into the expression “ [symbol] [symbol] (Transliteration: website-leul-mal-hae-jul-sue-it-a)” in the case in which polite level 0 has been selected for the conversation.

That is, the translation unit 130 applies the polite level selected by the polite level selection unit 120 to the conversation between the first and second language users, and each sentence of the conversation is output after undergoing morpheme analysis, structure analysis, and translation generation. In this case, it is determined whether a translation target sentence is present in a translation memory DB, and, if the translation target sentence is present, the translated sentence of the translation memory DB corresponding to the transferred polite level is output as translation results. In contrast, if the translation target sentence is not present in the translation memory DB, it is determined whether the translation target sentence may be applied to the translation pattern DB. If the translation target sentence may be applied to the translation pattern DB, the translated pattern of the translation pattern DB corresponding to the transferred polite level is output as translation results. If the translation target sentence is not present in the translation pattern DB, it is determined whether the translation target sentence may be applied to a translation dictionary DB. If the translation target sentence may be applied to a translation dictionary DB, the translated words of the translation dictionary DB corresponding to the transferred polite level are output as translation results.

For this purpose, the translation unit 130, as shown in FIG. 4, may include a polite expression generation unit 131, a morpheme analysis unit 132, a structure analysis unit 133, a translation generation unit 134, and a translation output unit 135.

The polite expression generation unit 131 generates polite expressions corresponding to the selected polite level.

The morpheme analysis unit 132 performs morpheme analysis on each sentence of the conversation between the first and second language users.

The structure analysis unit 133 analyzes the structure of each sentence of the conversation between the first and second language users. Here, the structure analysis unit 133 causes a polite expression to be selected while referring to a translation memory DB and a translation pattern DB.

The translation generation unit 134 generates a translation in which the sentences of the conversation between the first and second language users have been converted into a target language based on morphemes and structures obtained by analysis based on the generated polite expressions. In this case, the translation generation unit 134 causes honorific translated words to be selected while referring to the translation pattern DB and the translation dictionary DB.

The translation output unit 135 outputs the generated translation.

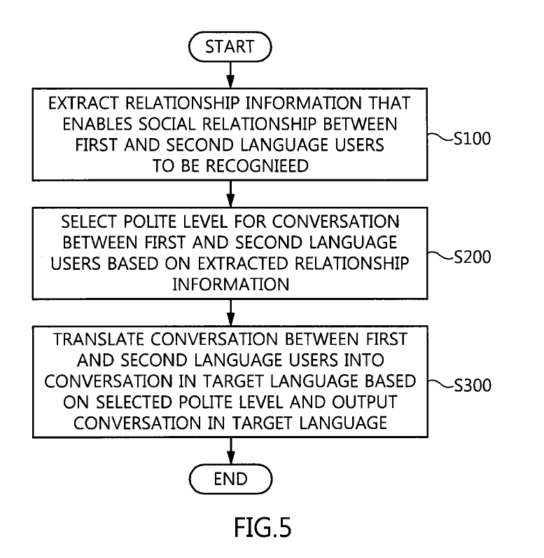

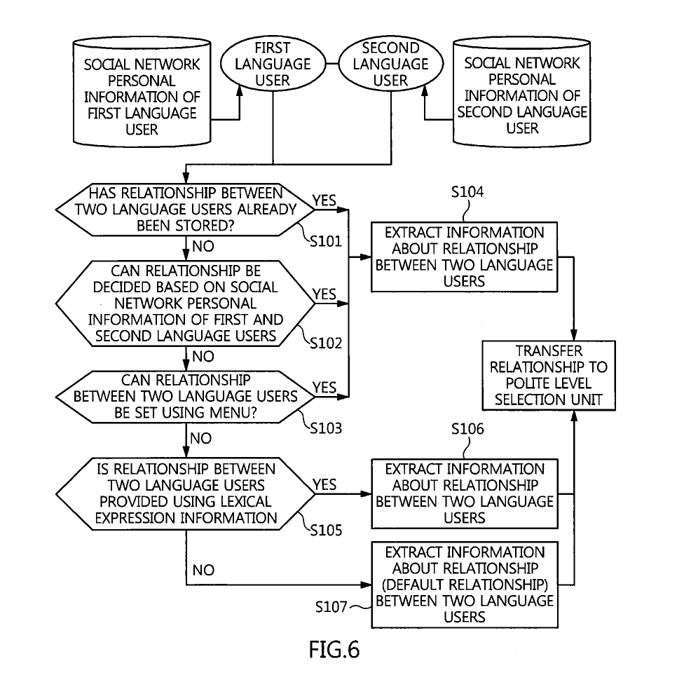

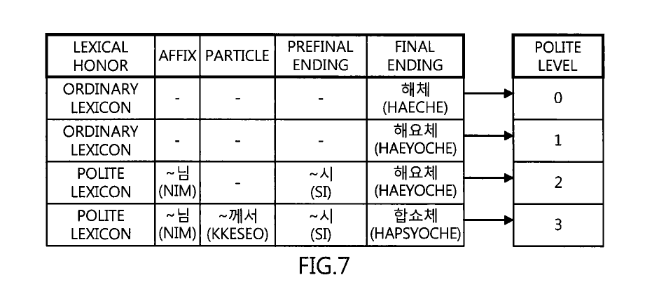

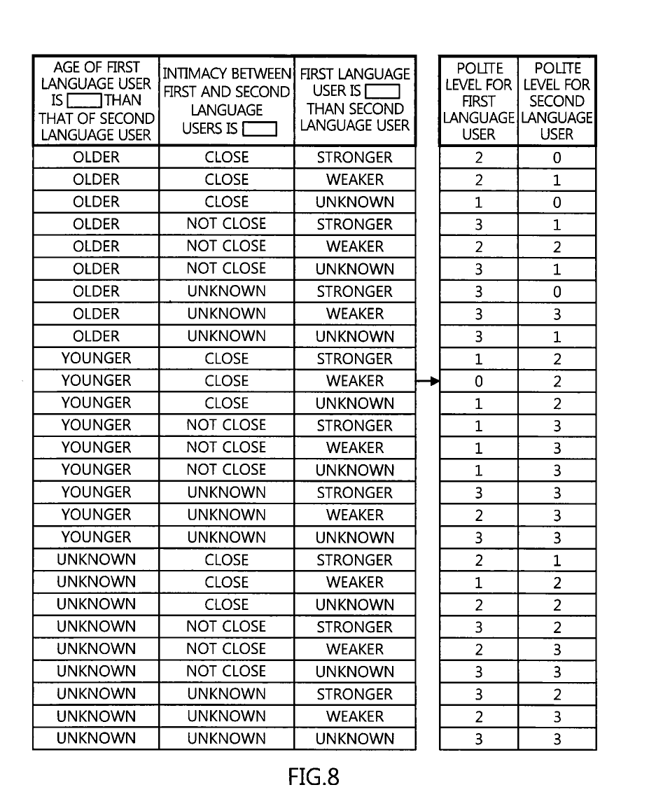

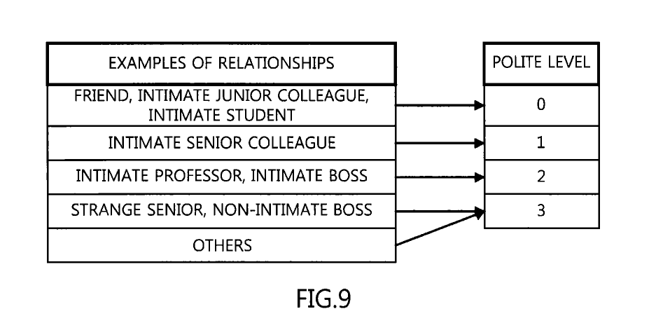

FIG. 5 is a flowchart showing a method of generating polite expressions for automatic translation according to an embodiment of the present invention, FIG. 6 is a flowchart showing the process of extracting relationship information that enables the social relationship between the first and second language users to be decided in the method of generating polite expressions for automatic translation according to the present invention, FIG. 7 is a flowchart showing the process of selecting the polite level for a conversation between the first and second language users based on relationship information based on extracted lexical expression information in the method of generating polite expressions for automatic translation according to the present invention, FIG. 8 is a flowchart showing the process of selecting a polite level for a conversation between the first and second language users based on relationship information based on extracted personal information in the method of generating polite expressions for automatic translation according to the present invention, and FIG. 9 is a flowchart showing the process of selecting a polite level for a conversation between the first and second language users based on relationship information received directly from users in the method of generating polite expressions for automatic translation according to the present invention.

Referring to FIG. 5, first, the method of generating polite expressions for automatic translation according to the present invention recognizes the social relationship between the language users by extracting relationship information from a conversation between the first and second language users and the personal information of the first and second language users using the relationship recognition unit 110 at step S100. That is, the relationship recognition unit 110 may extract information about the relationship between the first and second language users by analyzing the results of the part-of-speech classification of the lexical expression information collected from the conversation between the first and second language users. Alternatively, information about the relationship between the first and second language users may be extracted by analyzing personal information collected from social networks that are used by the first and second language users. Alternatively, relationship information may be received from the first and second language users.

The relationship recognition unit 110 recognizes the relationship between two users based on the social network personal information of the first language user and the social network personal information of the second language user, as shown in FIG. 6. First, when the relationship between the two users has already been stored at step S101, information about the relationship between the two language users is transferred to the polite level selection unit 120 at step S104. If the relationship between the two language users has not already been stored but the relationship can be decided using the social network personal information of the first and second language users at step S102, information about the relationship between the two language users is transferred to the polite level selection unit 120 at step S104. If the relationship between the two language users cannot be determined based on the personal information of the social network, the relationship between the two language users may be determined using a menu. If the relationship between the two language users can be determined using the menu at step S103, information about the determined relationship between the two language users is transferred to the polite level selection unit 120 at step S104. Meanwhile, if the relationship between the two language users cannot be also determined using the menu, the relationship between the first and second language users is determined using lexical expression information at step S105 and the relationship between two language users can be determined based on the lexical expressions of the conversation between the two language users, this is immediately transferred to the polite level selection unit 120 at step S106. In contrast, if information about the relationship between the two language users cannot be decided using lexical expressions, the default relationship is transferred to the polite level selection unit 120 at step S107.

Thereafter, a polite level for a conversation between the first and second language users is selected based on the extracted relationship information using the polite level selection unit 120 at step S200. That is, the polite level selection unit 120 selects a polite level for the conversation between the first and second language users by performing mapping to one of a plurality of polite levels, as shown in FIGS. 7 to 9.

Thereafter, using the translation unit 130, polite expressions corresponding to the selected polite level are generated and then a conversation between the first and second language users is translated into the target language based on the generated polite expressions at S300. That is, the translation unit 130 may generate a translation in which the sentences of the conversation between the first and second language users have been translated into the target language while referring to morphemes and structures obtained by the analysis of the generated polite expressions, and then output it.

The present invention has the advantage of recognizing the social relationship with an interlocutor based on non-linguistic information such as personal information provided by a social network, and linguistic information such as conversational expressions, when translating a conversation between first and second language users into a target language, thereby overcoming linguistic and cultural differences between polite expressions and then providing automatic translation results.

The present invention has the advantage of recognizing the social relationship with an interlocutor and selecting a polite level for a conversation between first and second language users, thereby providing automatic translation results suitable for the interlocutor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for generating polite expressions for automatic translation, comprising:
a relationship recognition unit for extracting relationship information from a conversation between first and second language users and personal information of the first and second language users and then recognizing the social relationship between the language users;
a polite level selection unit for selecting a polite level for the conversation between the first and second language users based on the extracted relationship information; and
a translation unit for generating polite expressions corresponding to the selected polite level and translating the conversation between the first and second language users into a target language based on the generated polite expressions.

2. The apparatus of claim 1, wherein the relationship information is information comprising at least one of lexical expression information, age information, relationship intimacy information and social association information extracted from the conversation and the personal information.

3. The apparatus of claim 1, wherein the relationship recognition unit comprises:
a first information collection unit for collecting lexical expression information from the conversation between the first and second language users;
a part-of-speech classification unit for classifying the collected lexical expression information into parts of speech; and
a first information extraction unit for extracting the information about the relationship between the first and second language users by analyzing results of the classification into the parts of speech.

4. The apparatus of claim 3, wherein the part-of-speech classification unit classifies the lexical expression information into parts of speech such as a lexical honor, an affix, a particle, a prefinal endings, and a final ending.

5. The apparatus of claim 1, wherein the relationship recognition unit comprises:
a second information collection unit for collecting personal information from social networks that are used by the first and second language users; and
a second information extraction unit for extracting the information about the relationship between the first and second language users by analyzing the collected personal information.

6. The apparatus of claim 1, wherein the relationship recognition unit comprises an information provision unit for receiving the relationship information from the first and second language users and providing the relationship information.

7. The apparatus of claim 1, wherein the polite level selection unit comprises:
a level classification unit for classifying a polite level into a plurality of preset polite levels; and
a level mapping unit for selecting and assigning a polite level for the conversation between the first and second language users by mapping the extracted relationship information into one of the classified polite levels.

8. The apparatus of claim 1, wherein the translation unit comprises:
a polite expression generation unit for generating the polite expressions corresponding to the selected polite level;
a morpheme analysis unit for performing morpheme analysis on sentences of the conversation between the first and second language users;
a structure analysis unit for analyzing structures of the sentences of the conversation between the first and second language users while referring to a translation memory DB and a translation pattern DB;
a translation generation unit for generating a translation in which the sentences of the conversation between the first and second language users have been converted into the target language while referring to morphemes and structures, obtained by the analysis based on the generated polite expressions, and the translation pattern DB and a translation dictionary DB; and
a translation output unit for outputting the generated translation.

9. A method of generating polite expressions for automatic translation, comprising:
extracting relationship information from a conversation between first and second language users and personal information of the first and second language users, and then recognizing the social relationship between the language users;
selecting a polite level for the conversation between the first and second language users based on the extracted relationship information; and
generating polite expressions corresponding to the selected polite level, and translating the conversation between the first and second language users into a target language based on the generated polite expressions.

10. The method of claim 9, wherein the recognizing the social relationship between the language users comprises extracting the information about the relationship between the first and second language users by analyzing results obtained by classifying lexical expression information, collected from the conversation between the first and second language users, into parts of speech.

11. The method of claim 9, wherein the recognizing the social relationship between the language users comprises extracting the information about the relationship between the first and second language users by analyzing personal information collected from social networks that are used by the first and second language users.

12. The method of claim 9, wherein the recognizing the social relationship between the language users comprises receiving the relationship information from the first and second language users.

13. The method of claim 9, wherein the selecting a polite level for the conversation between the first and second language users comprises selecting the polite level for the conversation between the first and second language users by performing mapping to one of a plurality of preset levels.

14. The method of claim 9, wherein the translating the conversation between the first and second language users into a target language comprises generating and outputting a translation in which sentences of the conversation between the first and second language users have been converted into the target language while referring to morphemes and structures obtained by analysis based on the generated polite expressions.
